(19) United States
(12) Patent Application Publication
(10) Pub. No.: US 2005/0049532 A1
(43) Pub. Date: Mar. 3, 2005

(54) Massaging apparatus

(76) Inventor: Chin-Tsun Lee, Yongkang City (TW)

Correspondence Address: CHIN-TSUN LEE, P.O. Box 90, Tainan City, 704, TW

(21) Appl. No.: 10/650,747

(22) Filed: Aug. 29, 2003

(51) Int. Cl. A61H 15/00

(52) U.S. Cl. 601/118; 601/122

(57) ABSTRACT

A massaging apparatus includes a base body formed with a recess having insert holes. The recess has the opposite vertical walls respectively provided with a projecting stud. A positioning base assembled in the recess has two projecting studs respectively secured on the opposite sides and threaded holes in the bottom. Massaging bodies are fitted between the recess and the positioning base, having opposite ends respectively bored with a shaft hole. A slip-preventing pad assembled under the base body consists of a soft pad body and a hard board provided on the pad body. In assembling, each massaging body has its shaft holes respectively inserted with the projecting stud of the base body and the positioning base which is then fixed in the cut groove of the base body by bolts.

### BACKGROUND OF THE INVENTION

1. Field of the Invention

This invention relates to a massaging apparatus, particularly to one having a base body formed with a lengthwise recess having two insert holes in the intermediate portion for two bolts to be inserted therethrough. The recess has its opposite walls respectively provided with a transverse projecting stud. A positioning base fixed in the recess of the base body has two transverse projecting studs respectively secured on the opposite sides and two threaded holes bored in the bottom side. Two massaging bodies are respectively assembled between the recess of the base body and the positioning base, and each massaging body has its opposite ends respectively bored with a shaft hole. A slip-preventing pad assembled under the base body consists of a soft pad body and a hard board provided on the topside. In assembling, each massaging body has its shaft holes respectively inserted with the projecting studs of the base body and the positioning base, which is then fixed in the recess of the base body by bolts.

2. Description of the Prior Art

A conventional massaging apparatus 1, as shown in FIG. 1, includes two bases 10 and plural shafts 12 assembled therebetween. Each shaft 12 is fitted thereon with lots of rollers 13. In using, the massaging apparatus 1 is positioned on the ground and a user has his feet soles stepping on the rollers 13 and moving to and fro thereon for massaging. However, the conventional massaging apparatus 1 is mostly made of wood or plastic; therefore when a user's feet soles moves to and fro on the rollers 13, the massaging apparatus 1 is likely to slip, rendering the rollers 13 unable to roll smoothly. Besides, to assemble the conventional massaging apparatus 1, the rollers 13 have to be respectively fitted on the shafts 12 one by one, and then the shafts 12 are assembled between the two bases 10, increasing trouble and wasting time in assembling.

### SUMMARY OF THE INVENTION

The objective of the invention is to offer a massaging apparatus able to be assembled conveniently and quickly and to prevent its base body from slipping.

One feature of the invention is a base body formed with a lengthwise recess having insert holes in the intermediate portion, a positioning base fixed in the recess of the base body, plural massaging bodies respectively assembled between the recess of the base body and the positioning base, and a slip-preventing pad firmly assembled under the base body, consisting of a soft pad body and a hard board fixed on the topside.

Another feature of the invention is a base body formed with a lengthwise recess and having a plurality of reinforcing lateral plates provided in the interior. The two reinforcing lateral plates provided near the opposite ends of the base body are respectively provided thereon with two upright fixing posts, and the fixing posts of the reinforcing lateral plate near the right end of the recess are respectively bored with an insert hole passing upward through the recess. A positioning base fixed in the recess of the base body is bored with threaded holes in the bottom side. Plural massaging bodies are respectively assembled between the recess of the base body and the positioning base. A slip-preventing pad consisting of a soft pad body and a hard board provided on the topside is fixedly assembled under the base body and has its opposite ends respectively bored with insert holes matching with the fixing posts of the base body for bolts to be inserted therethrough.

### BRIEF DESCRIPTION OF DRAWINGS

This invention will be better understood by referring to the accompanying drawings, wherein:

FIG. 1 is a perspective view of a conventional massaging apparatus;

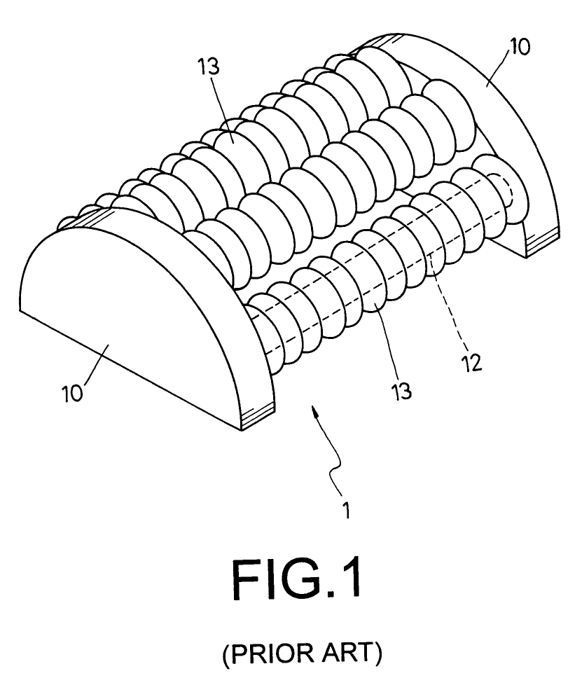

FIG. 2 is an exploded perspective view of a first preferred embodiment of a massaging apparatus in the present invention;

FIG. 3 is a perspective view of the first preferred embodiment of the massaging apparatus in the present invention;

FIG. 4 is a cross-sectional view of the first preferred embodiment of the massaging apparatus in the present invention;

FIG. 5 is an exploded perspective view of a second preferred embodiment of a massaging apparatus in the present invention;

FIG. 6 is an exploded perspective view of a third preferred embodiment of a massaging apparatus in the present invention; and,

FIG. 7 is an exploded perspective view of a fourth preferred embodiment of a massaging apparatus in the present invention.

### DETAILED DESCRIPTION OF THE PREFERRED EMBODIMENT

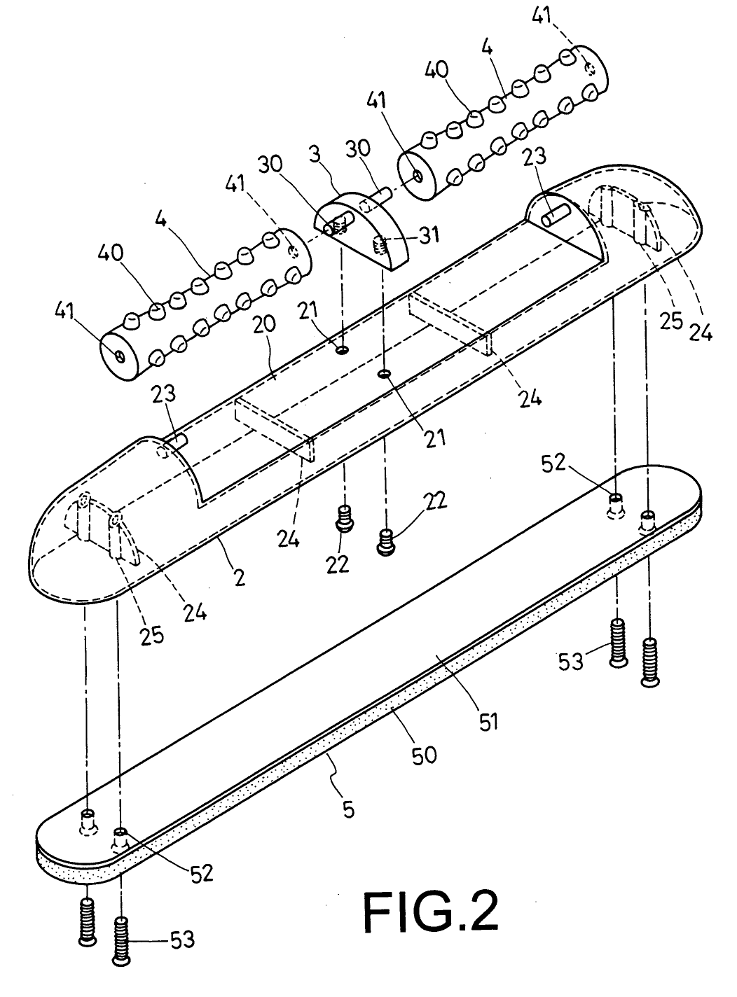

A first preferred embodiment of a massaging apparatus in the present invention, as shown in FIG. 2, includes a base body 2, a positioning base 3, two massaging bodies 4 and a slip-preventing pad 5 as main components combined together.

The base body 2 is formed with a lengthwise recess 20 having two insert holes 21 in the intermediate portion for two bolts 22 to be inserted therethrough. The recess 20 has its opposite walls respectively provided with a transverse projecting stud 23, and the base body 2 is provided with a plurality of reinforcing plates 24 in the interior. The reinforcing lateral plate 24 respectively positioned at the opposite ends of the base body 2 is secured thereon with two upright fixing posts 25.

The positioning base 3 to be fixed at the intermediate section of the recess 20 has two transverse studs 30 respectively fixed on the opposite sides and two threaded holes 31 bored in the bottom surface.

The two massaging bodies 4 are respectively fitted in the left and the right portion of the recess 20 of the base body 2, separated by the positioning base 3. Each massaging body 4 has its outer surface formed with numerous massaging knobs 40 and its opposite ends respectively bored with a shaft hole 41.

The slip-preventing pad 5 to be assembled under the base body 2 is a soft pad body 50 having a hard board 51 provided on the topside and has its opposite ends respectively bored with two insert holes 52 matching with the fixing posts 25 of the base body 2 for bolts 53 to be respectively screwed therein.

In assembling, as shown in FIGS. 2, 3 and 4, firstly, the two massaging bodies 4 respectively have the outside shaft hole 41 fitted with the projecting stud 23 on the opposite walls of the recess 20 of the base body 2, and have the inside shaft hole 41 fitted with the projecting stud 30 on the opposite sides of the positioning base 3, letting the positioning base 3 pressed to position in the cut groove 20 of the base body 2 and the two threaded holes 31 in the bottom side of the positioning base 3 respectively aligned to the two insert holes 21 in the cut groove 20 of the base body 2. Next, two bolts 22 are respectively inserted upward through the two insert holes 21 of the base body 2 and screwed with the two threaded holes 31 of the positioning base 3 to fix positioning base 3 in the recess 20 of the base body 2 and position the two massaging bodies 4 in the recess 20 of the base body 2. Lastly, the slip-preventing pad 5 is positioned under the base body 2, letting the insert holes 52 of the slip-preventing pad 5 respectively aligned to the fixing posts of the base body 2, and then bolts 53 are respectively inserted through the insert holes 52 of the slip-preventing pad 5 and screwed with the fixing posts 25 of the base body 2, thus finishing assembled of the massaging apparatus.

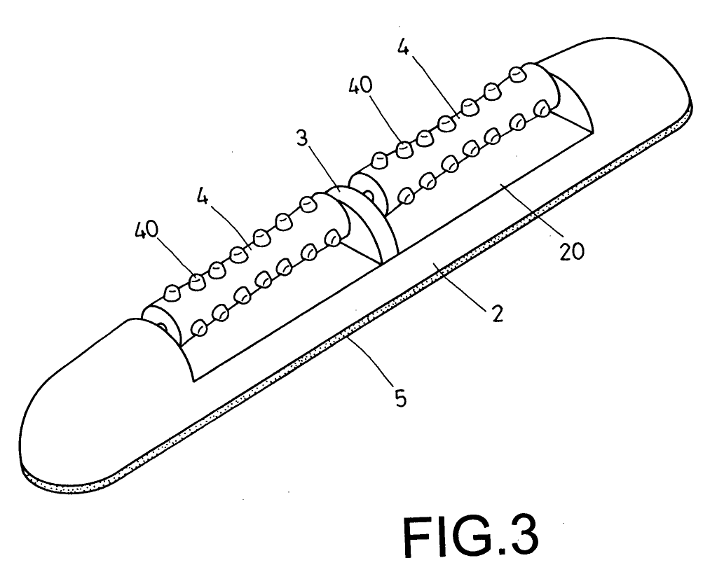

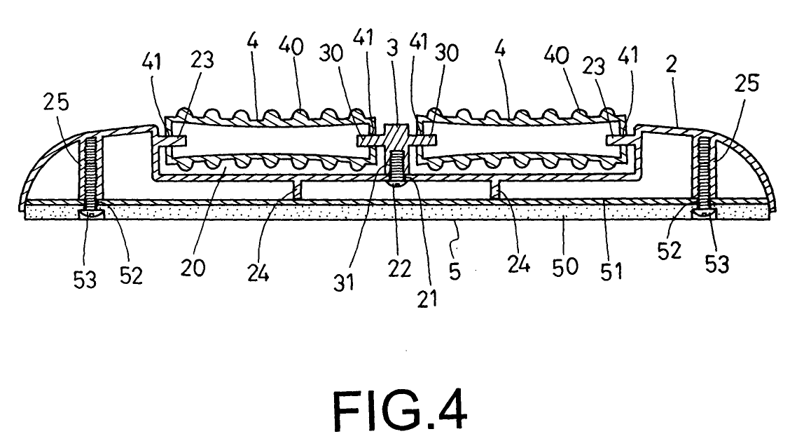

In using, as shown in FIGS. 3 and 4, a user has his feet stepping on the massaging bodies 4 of the base body 2 and moving to and fro on the massaging bodies 4, which are supported by the projecting studs 23, 30 and rotate thereon, to have the soles of his feet massaged by the massaging knobs 40 on the massaging bodies 4. In a process of massaging, the slip-preventing pad 5 under the base body 2 can prevent the base body 2 from slipping, and the hard board 51 assembled on the topside of the slip-preventing pad 5 can strengthen the slip-preventing pad 5 to prevent it from broken by pulling and dragging. As a matter of fact, having one's feet soles massaged by the massaging knobs 40 helps to promote blood circulation, reduce soreness and aching and get rid of exhaustion.

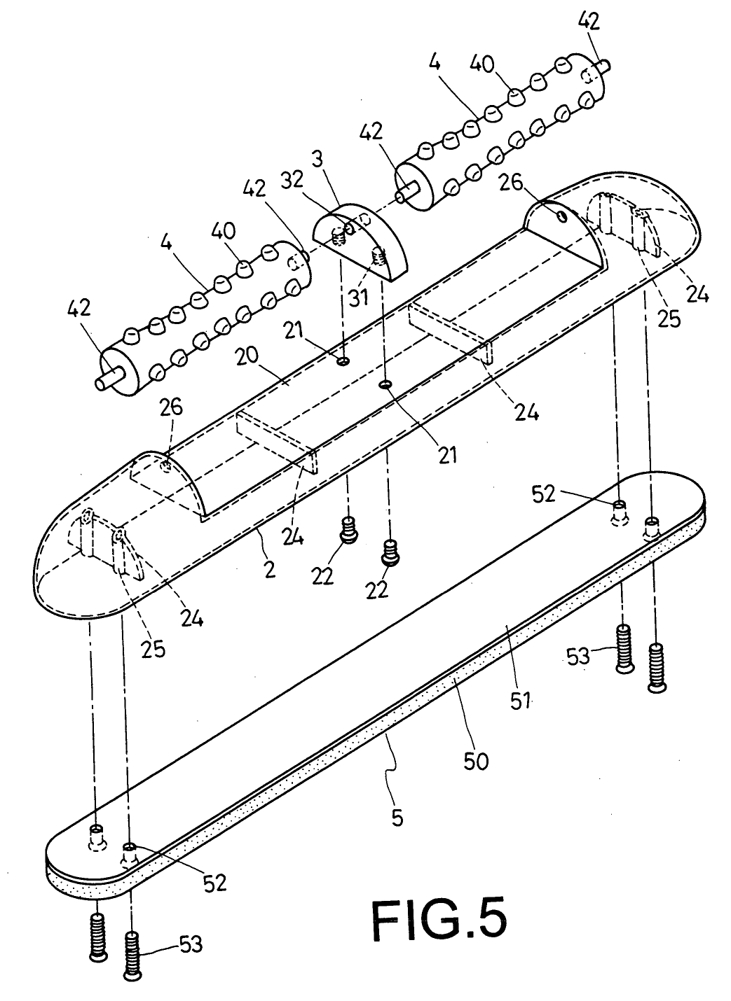

A second preferred embodiment of a massaging apparatus in the present invention, as shown in FIG. 5, is to have the opposite walls of the recess 20 of the base body 2 respectively bored with a shaft hole 26 instead of the projecting stud 23 in the first preferred embodiment, and the positioning base 3 has its opposite sides respectively bored with a through shaft hole 32 instead of the original projecting stud 30, and further the two massaging bodies 4 have the opposite ends respectively fixed with a transverse projecting stud 42 in place of the original shaft hole 41. In assembling, the projecting studs 42 on the opposite ends of each massaging body 4 are respectively inserted in the shaft hole 26 of the base body 2 and the shaft hole 32 of the positioning base 3. Next, the positioning base 3 is fixed in the recess 20 of the base body 2 by two bolts 22 and the slip-preventing pad 5 is fixedly assembled under the base body 2 by bolts 53 to finish assembly of the second embodiment of the massaging apparatus. The massaging apparatus of this preferred embodiment has the same operating process and effect as the first preferred embodiment.

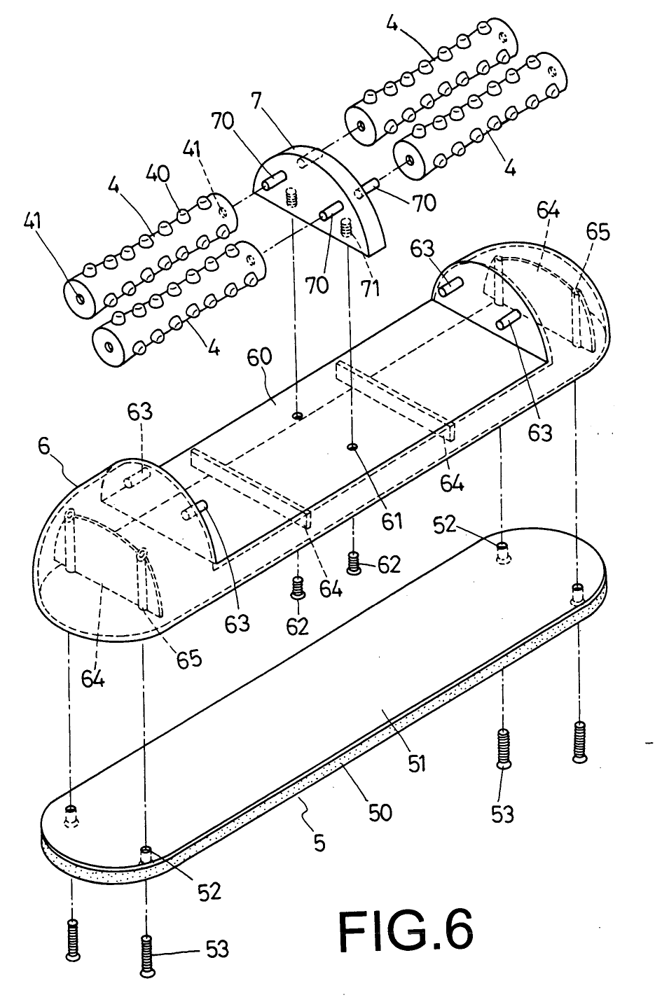

A third preferred embodiment of a massaging apparatus in the present invention, as shown in FIG. 6, includes a base body 6, a positioning base 7, plural massaging bodies 4 and a slip-preventing pad 5.

The base body 6 is formed with a lengthwise recess 60 having its left and right portion respectively fitted therein with at least two massaging bodies 4. The recess 60 of the base body 6 has its intermediate portion bored with two insert holes 61 for two bolts 62 to be respectively screwed therethrough and has its opposite vertical walls respectively provided with at least two transverse projecting studs 63. Further, the base body 6 is provided with plural reinforcing lateral plates 64 in the interior, and the reinforcing lateral plate 64 at the opposite ends of the base body 6 is provided with upright fixing posts 65.

The positioning base 7 to be fixed at the intermediate section of the recess 60 of the base body 6 has its opposite sides respectively secured thereon with at least two transverse projecting studs 70 and its bottom surface bored with two threaded holes 71.

The two sets of massaging bodies 4 (four massaging bodies in all) are respectively fitted in the left and the right portion of the recess 60 of the base body 6. The slip-preventing pad 5 is assembled under the base body 6.

In this third preferred embodiment, at least four massaging bodies 4 are provided on the base body 6, able to increase massaging contact points on a user's feet soles.

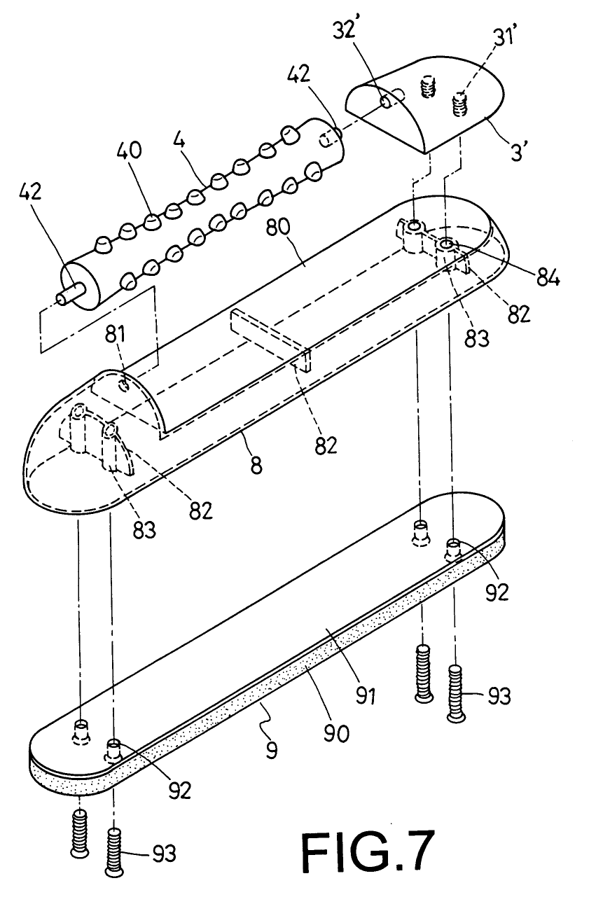

A fourth preferred embodiment of a massaging apparatus in the present invention, as shown in FIG. 7, includes a base body 8, a positioning base 3′, a massaging body 4 and a slip-preventing pad 9.

The base body 8 is formed with a lengthwise recess 80 having a shaft hole 81 in the left wall and has plural reinforcing lateral plates 82 provided in the interior. The two reinforcing lateral plates 82 respectively positioned at the opposite ends of the base body 8 are respectively provided with two upright fixing posts 83, and the reinforcing lateral plate 82 near the right end of the recess 80 has its two fixing posts 83 respectively bored with an insert hole 84 passing upward through the recess 80.

The positioning base 3′ to be fixed in the recess 80 of the base body 8 has its vertical side wall bored with a shaft hole 32′ and its bottom side bored with two threaded holes 31′.

The massaging body 4 fitted in the recess 80 of the base body 8 and abutting against the positioning base 3′ has its outer surface formed with numerous massaging knobs 40 and its opposite ends respectively fixed thereon with a transverse projecting stud 42.

The slip-preventing pad 9 assembled under the base body 8 has a soft pad body 90 and a hard board 91 provided on the topside. The slip-preventing pad 9 has its opposite ends respectively bored with insert holes 92 matching with the fixing posts 83 of the base body 8 for bolts 93 to be inserted therethrough.

In assembling the fourth embodiment, the massaging body 4 has its projecting studs 42 respectively inserted in the shaft hole 81 of the base body 8 and the shaft hole 32′ of the positioning base 3′. Next, the positioning base 3′ is positioned in the recess 80 of the base body 8, letting its threaded holes 31′ aligned to the insert holes 84 of the base body 8 and the insert holes 92 of the slip-preventing pad 9. Then, two bolts 93 are respectively inserted upward through the insert holes 92 of the slip-preventing pad 9 and the insert holes 84 of the base body 8 and then screwed with the threaded holes 31′ of the positioning base 3′, and another two bolts 93 are respectively inserted through the insert holes 92 of the slip-preventing pad 9 and screwed with the fixing posts 83 of the base body 8 to fix the massaging body 4, the positioning base 3′ and the slip-preventing pad 9 on the base body 8.

As can be noted from the above description, this invention has the following advantages.

1. It can be assembled conveniently and quickly and used stably.

2. The slip-preventing pad provided under the base body can prevent the base body forming slipping, and the hard board assembled thereon protects the slip-preventing pad and prolongs its service life.

3. It has effect of massaging one's feet soles to help promote blood circulation, reduce soreness and aching and get rid of exhaustion.

While the preferred embodiments of the invention have been described above, it will be recognized and understood that various modifications may be made therein and the appended claims are intended to cover all such modifications that may fall within the spirit and scope of the invention.

1. A massaging apparatus comprising:
a base body formed with a lengthwise recess, said recess having insert holes in an intermediate portion;
a positioning base fixed in said recess of said base body;
massaging bodies respectively assembled in the left and the right portion of said recess of said base body, said massaging bodies respectively having the inner end abutting against said positioning base;
a slip-preventing pad assembled under said base body, said slip-preventing pad made of a soft pad body, said pad body having a hard board provided on the topside; and,
said massaging bodies respectively positioned between said base body and said positioning base, said positioning base fixed in said recess of said base body, said slip-preventing pad assembled under said base body, thus finishing assembly of said massaging apparatus.

2. The massaging apparatus as claimed in claim 1, wherein said recess of said base body has its opposite walls respectively provided with a transverse projecting stud, said positioning base has its opposite sides respectively provided with a transverse projecting stud, and each said massaging body has its opposite ends respectively bored with a shaft hole for receiving therein said transverse projecting stud of said base body and said positioning base.

3. The massaging apparatus as claimed in claim 1, wherein said recess of said base body has its opposite walls respectively bored with a shaft hole, and said positioning base has its opposite sides respectively bored with a shaft hole and each said massaging body has its opposite ends respectively secured thereon with a transverse projecting stud to be respectively inserted in said shaft hole of said base body and said positioning base.

4. The massaging apparatus as claimed in claim 1, wherein said base body is provided with a plurality of reinforcing lateral plate in the interior, and said reinforcing plate at the opposite ends of said base body is provided with two upright fixing posts, and said slip-preventing pad has its opposite ends respectively bored with two insert holes matching with said two fixing posts of said base body, with bolts respectively inserted through said insert holes and screwed with said fixing posts to fix said slip-preventing pad under said base body.

5. A massaging apparatus comprising:
a base body formed with a lengthwise recess, said base body provided with a plurality of reinforcing lateral plates in the interior, said reinforcing lateral plate at the opposite ends of said base body provided with two upright fixing posts, said reinforcing lateral plate at the right end of said recess of said base body having said two fixing posts respectively bored with a vertical insert hole passing upward through said cut groove;
a positioning base fixed in said cut groove of said base body, said positioning base bored with two threaded holes in the bottom side;
a massaging body assembled between said recess of said base body and said positioning base;
a slip-preventing pad assembled under said base body, said slip-preventing pad consisting of a soft pad body and a hard board placed on said soft pad body, said slip-preventing pad having the opposite ends respectively bored with two insert holes matching with said fixing posts at the opposite ends of said base body, bolts respectively inserted through said insert holes to fix said slip-preventing pad on said base body; and,
said massaging body fitted between said recess of said base body and said positioning base, said positioning base positioned in said recess of said base body, said positioning base having its threaded holes in the bottom side aligned to said insert holes of said base body and said slip-preventing pad, said massaging body and said positioning base and said slip-preventing pad together assembled on said base body by said bolts respectively inserted through said insert holes of said slip-preventing pad and said base body and then screwed with said threaded hole of said positioning base.
